(19) United States
(12) Patent Application Publication
(10) Pub. No.: US 2007/0126742 A1
(43) Pub. Date: Jun. 7, 2007

(54) Movement management system for a cellular telephone

(76) Inventors: Adi Bar-Lev, Montreal (CA); Gady Rozin, Tel-Aviv (IL)

Correspondence Address: Martin D. Moynihan;PRTSI, Inc., P.O. Box 16446, Arlington, VA, 22215, US

(21) Appl. No.: 11/295,544

(22) Filed: Dec. 7, 2005

(51) Int. Cl. G06T 15/70

(52) U.S. Cl. 345/473

(57) ABSTRACT

Apparatus for transition management in an a priori undefined animation sequence that combines a plurality of separate animation clips having a category determination unit for determination of category classifications of succeeding animation clips in a sequence and indicating whether the category classifications are the same or different, and a blending unit for defining the blending operation depending on the category determination, resulting in a smooth overall transition.

### FIELD AND BACKGROUND OF THE INVENTION

The present invention relates to a movement and animation management system for a cellular telephone or like mobile device.

When dealing with skeletal 3D characters in the 3D gaming world in general, and in the field of a priori undefined animation sequences in particular, there are usually a variety of animation clips which can be run in order to set the character's movements. That is to say there are animation clips that define basic movements of the character. More complex movements are produced by joining simple movement clips one after the other, with the system having to blend the clips together.

By skeletal is meant characters with a definite movement that would in real life be defined by a skeleton of some kind.

By a priori undefined animation sequences is meant that the animation sequence is only defined when the animation takes place, that is it depends on inputs during the course of a game or other interactive session. Thus a complete sequence of motion cannot be recorded in advance but partial animations or animation clips have to be linked to each other at runtime to form the sequence.

If we desire to control the motion of the character and match between the animation clips and the way the character moves and behaves, we need to have a control mechanism over the animation sequences. It is not possible to join together any two clips. Rather, the two clips have to match so that one clip can smoothly fade into the next.

In order to run games involving animations in which the animated character can perform situation-defined scripts a complex control mechanism is required. Such a mechanism is referred to as a ‘Character Movement Manager’.

A simple example of the kind of task that the character movement manager has to carry out is to have a character move with an adequate velocity and then turn towards a target. The movement manager initially plays a walk animation, and then selects a turn animation that turns from the walk direction to the target direction and which matches the walk animation in terms of stance or posture or direction being faced at the start. The manager then fades smoothly from the walk animation into the turn animation to turn towards the desired target location.

Now, controlling only the animations in this case is obviously not enough. One needs to also match the velocity of the character, and to navigate it in 3D space. All of this, together with the desire to make the control as simple as possible for the user, forms the need for the Movement Manager.

The movement manager preferably includes a set of high level qualities:
Easy to use.
Transparent to the user—does not need intervention by the user in order to set animations blending, transitions, or any other low level control.
High level control—when the character needs to make a motion or switch between two types of motions, the movement manager is able to activate and combine the motions seamlessly and without user intervention, and if needed, combine other animation sequences without user knowledge.
Maximum user control is required over the motions themselves.
The movement manager should have the ability to change to a direct user control mode. The direct mode may override the automatic mode described above and is useful for testing of animations and the like.

Now the above is true of gaming in general. New animations to be mixed in have to be made available fast so that the changeover is smooth and invisible to the eye of the observer. Computer systems such as PC's, laptops, Gaming consoles and the like, have traditionally achieved the above by copying hundreds or more usually thousands of animations into the volatile memory of the machine and then selecting the most suitable animation as required. In more advanced PC and console games today they use other methods for blending, which also achieve a high level of movement control.

A problem arises when wishing to carry out a priori undefined animation sequences on a cellular telephone. Resources on a cellular telephone are much more limited since the device is designed to save battery power and more resources simply drain power. The cellular telephone simply does not have the resources to store multiple frames in its volatile memory.

There is thus a need for, and it would be highly advantageous to have, a cellular telephony system that can operate a priori undefined animation sequences despite the above limitations.

### SUMMARY OF THE INVENTION

According to one aspect of the present invention there is provided Method for movement management in an a priori undefined animation sequence comprising a plurality of movement clips, comprising:

selecting, from a relatively slow memory, movement clips of a plurality of different categories,

placing said selected movement clips in a current movement clip register being in relatively fast memory; and

selecting a movement clip for playing, by taking a movement clip of a currently desired category from said current movement clip register.

According to a second aspect of the present invention there is provided Method for transition management in an a priori undefined animation sequence that combines a plurality of separate animation clips, the method comprising:

a) determining of category classifications respectively of a first and a succeeding animation clip in said sequence and indicating whether said category classifications are the same or different, and

b) i) blending said first animation clip directly into said succeeding animation clip if said category classifications are the same, and
ii) selecting a bridging animation clip for bridging between said first and said succeeding animation units if said category classifications are different, such that said first animation clip is blended into said bridging animation clip and said bridging animation clip is blended into said succeeding animation clip.

According to a third aspect of the present invention there is provided Apparatus for movement management in an a priori undefined animation sequence comprising a plurality of movement clips, for use in a limited resource device having permanent memory and a limited amount of faster volatile memory, the apparatus comprising:

a) a movement clip register in said volatile memory able to take a limited number of movement clips at any given time;

b) a resource management unit for placing animation clips of a plurality of different categories from said permanent memory in said movement clip register;

c) a movement manager unit for defining an intended movement of a given character; and

d) a track manager, associated with said resource management unit, for translating an intended movement into a series of movement clips, and ensuring that said resource management unit has clips of said series available in said volatile memory.

The functionality of the track manager is typically carried out by the smAnimation tracks editor to be described below.

According to a fourth aspect of the present invention there is provided Apparatus for transition management in an a priori undefined animation sequence that combines a plurality of separate animation clips, the apparatus comprising:

a) a category determination unit for determination of category classifications respectively of a first and a succeeding animation clip in said sequence and indicating whether said category classifications are the same or different, and

b) a blending unit configured for:
i) blending said first animation clip directly into said succeeding animation clip if said category classifications are the same, and
ii) selecting a bridging animation clip for bridging between said first and said succeeding animation units if said category classifications are different, such that said first animation clip is blended into said bridging animation clip and said bridging animation clip is blended into said succeeding animation clip.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram illustrating some of the resources typically available in the cellular telephone environment;

FIGS. 2a and 2b are schematic diagrams illustrating stance categories and bridging animations according to a preferred embodiment of the present invention;

FIG. 3 is a block diagram illustrating a transition manager unit according to a preferred embodiment of the present invention;

FIG. 4 is a graph illustrating a direct transition between clips under operation of the transition manager of FIG. 3;

FIG. 5 is a graph illustrating an indirect transition between clips under operation of the transition manager of FIG. 3;

FIG. 6 is a simplified block diagram illustrating the hierarchy of elements within a system involving a movement manager according to a preferred embodiment of the present invention;

FIG. 7 is a simplified diagram illustrating the hierarchical arrangement extending from the game AI to the memory management and including track selection, according to a preferred embodiment of the present invention; and

FIG. 8 is a simplified block diagram illustrating an arrangement of classes and objects to create animation management according to a preferred embodiment of the present invention.

### DESCRIPTION OF THE PREFERRED EMBODIMENTS

The present embodiments comprise an apparatus and a method for management of the limited resources on a cellular telephone in order to play a priori undefined animation sequences. The embodiments operate by modifying the movement manager generally required for such sequences to work with a classified set of animation clips wherein all clips in the same classification can be blended into one another and wherein specific bridging animations are provided for moving between one classification and another. The limited volatile memory or other fast cache in the system then holds only a limited number of clips, typically just one, per category plus the bridging animations.

Furthermore, movements are defined separately from the structures or skins of individual characters, so that a desired movement can be downloaded into a track in fast memory and then be separately rendered for individual characters. This reduces the total amount of data needed in fast memory.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

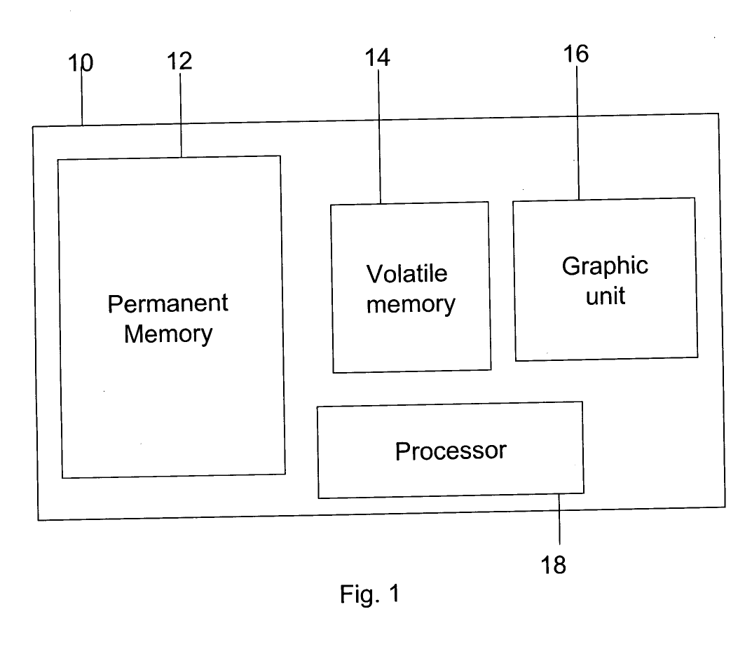

Reference is now made to FIG. 1, which is a simplified diagram illustrating schematically some of the resources available on a third generation cellular telephone device. Third generation cellular telephone device 10 comprises permanent memory 12, typically a Flash memory. In addition there is a volatile or cache memory 14 which is a much faster access memory than permanent memory 12. There is also a graphic unit 16 or graphic driver which provides color graphics for the screen and processor 18 which provides overall control for the telephone.

A game or like program that comprises a priori undefined animation sequences to be played, would typically be stored in permanent memory 12. For playing, however, the animation sequences likely to be used in the near future cannot be retrieved fast enough from permanent memory 12 and thus have to be placed in volatile memory or cache 14. Prior art systems generally had sufficient continuation clips ready in the RAM or other fast memory so that continuation actions could be blended into most possible current actions. However cache 14 is only able to store a limited number of animation clips and therefore the prior art approach, designed for the level of resources available on a personal computer or games console, is not suitable for the much more limited cellular environment.

It is noted that the animation clips referred to herein could be fully rendered animation clips or they could be mere definitions of movements or stances for rendering onto a given character.

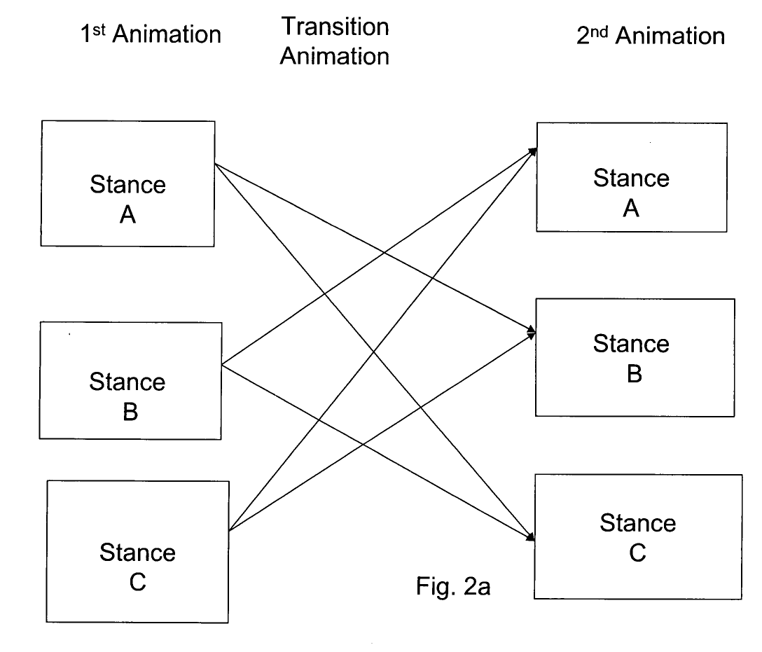

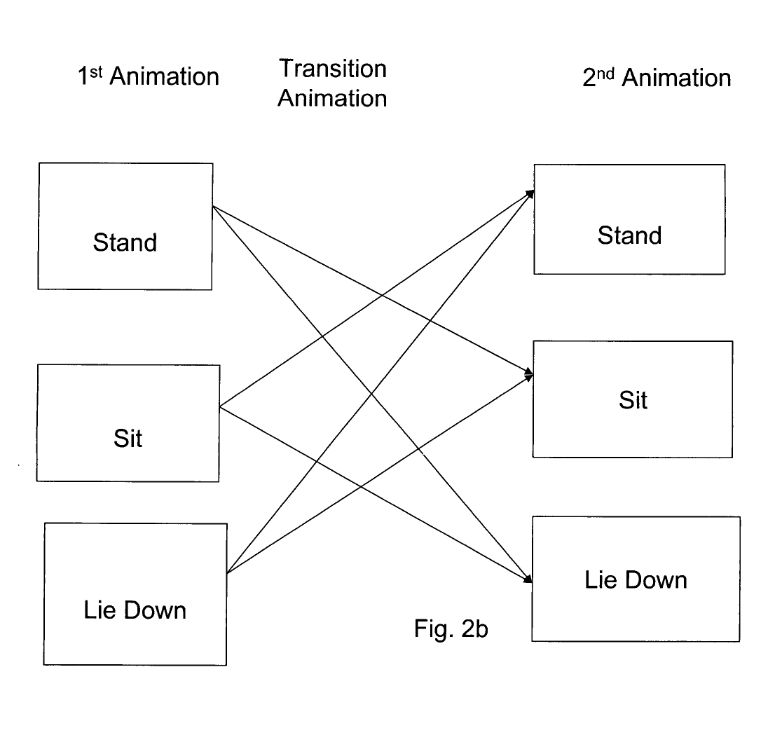

Reference is now made to FIGS. 2a and 2b, which are simplified diagrams illustrating a scheme for managing animation clips for a limited resource environment according to a preferred embodiment of the present invention. A particular animation sequence is centered on a given animated character. The character may carry out an essentially unlimited number of actions but the actions can all be categorized under a limited number of stances indicated by A, B and C. As shown in FIG. 2B, A represents a standing stance, B represents a sitting stance and C represents a lying down stance. Thus the character may begin, in a first animation, in a standing stance (A), a sitting stance (B) or a lying down stance (C), and the following animation may likewise be any of the three stances. As long as succeeding clips are in the same category of stance, the clips are able to blend directly into each other. However, if the succeeding categories are not the same then a smooth transition cannot be achieved by direct blending.

In order to solve the above problem and allow for blending between succeeding clips of different category, transition animations are provided for bridging between the different categories. In the case of three stances, six linking animations, indicated by the six category crossing arrows in the figure, are provided for the six change combinations between the categories illustrated, thus allowing for changes in both directions. It will be appreciated that more than three stance types categories can be used, in which there may be more than six transition animations. If two succeeding clips are in a different category then the transition animations are used so that the first animation transitions or fades into the transition animation and the transition animation then fades into the second animation.

The transition animations indicated in the figure show the character moving from standing to sitting (AB) standing to lying (AC), sitting to standing (BA), sitting to lying (BC), lying to standing (CA) and lying to sitting (CB).

It is pointed out that the system is naturally additive and additional stances can be introduced with ease.

It is further pointed out that the stances and movements are stored independently of the characters. A given stance or movement can be rendered independently for different characters and, as will be explained in greater detail below, commonly used stances or movements can be maintained in the fast memory.

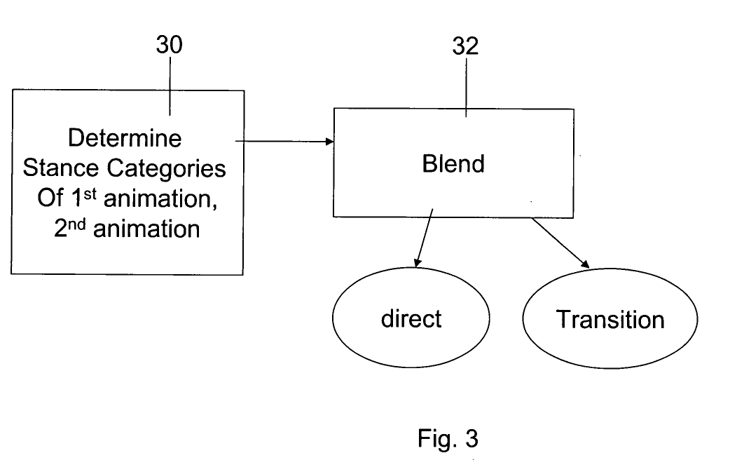

Reference is now made to FIG. 3, which is a simplified diagram illustrating a transition management unit for managing transitions or fades utilizing the scheme of FIG. 2. The transition manager is a functional unit within a movement manager, as will be discussed in greater detail hereinbelow.

The transition manager comprises a stance category determination unit 30 which looks at the current animation and the next animation and determines which categories each belongs to. The simplest way to apply category determination is to supply the category as metadata with the clip itself, and then the category determination unit simply needs to look at the metadata. The category determination unit then either decides that the categories are the same, in which case the clips can blend or fade into one another directly, or it decides that the categories are different, in which case a bridge animation is needed to bridge between them.

A blending unit 32 is connected to the output of the category determination unit 30 and carries out the blending operation in accordance with the instructions of the category determination unit. Thus it manages either direct transitions or indirect transitions via a bridging clip as appropriate.

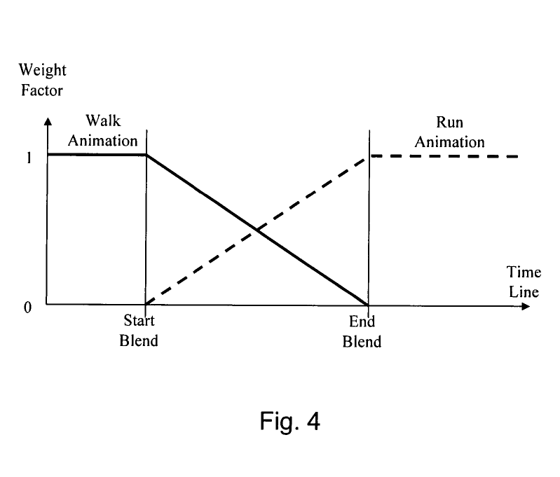

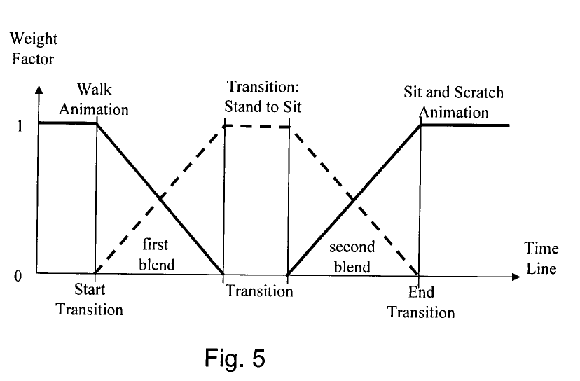

FIGS. 4 and 5 are graphs of clip weight factor against time and illustrate the blending process when carrying out transitions between clips. FIG. 4 illustrates the direct transition. Specifically, it shows a transition from a walk animation to a run animation. Both animations belong to the category of standing so a direct transition is possible. The first clip is faded out as the second clip is faded in, to provide a smooth blending of the two.

FIG. 5 is again a graph of clip weight factor against time, and this time illustrates the transition between two different stances for an animated character, the character being a dog. The transition is between a walk clip and a sit-up and scratch clip. The two animations are in different stance categories, the first being the stand category and the second being the sit category. Thus a stand to sit bridging clip is required. The walk clip fades to the bridging clip. The dog sits, and the bridging clip fades to the sit and scratch clip.

It will be appreciated that for any given character there will be numerous animation clips for carrying out different activities, say walking, idling, sleeping, jumping, eating, and turning. Not all activities need to be retained at all times in fast memory, but efficient memory management demands a minimal number of clips that can keep the animation sequence appearing smooth and natural. At least the current clip and most likely succeeding clips need to be retained, as well as all the bridging clips.

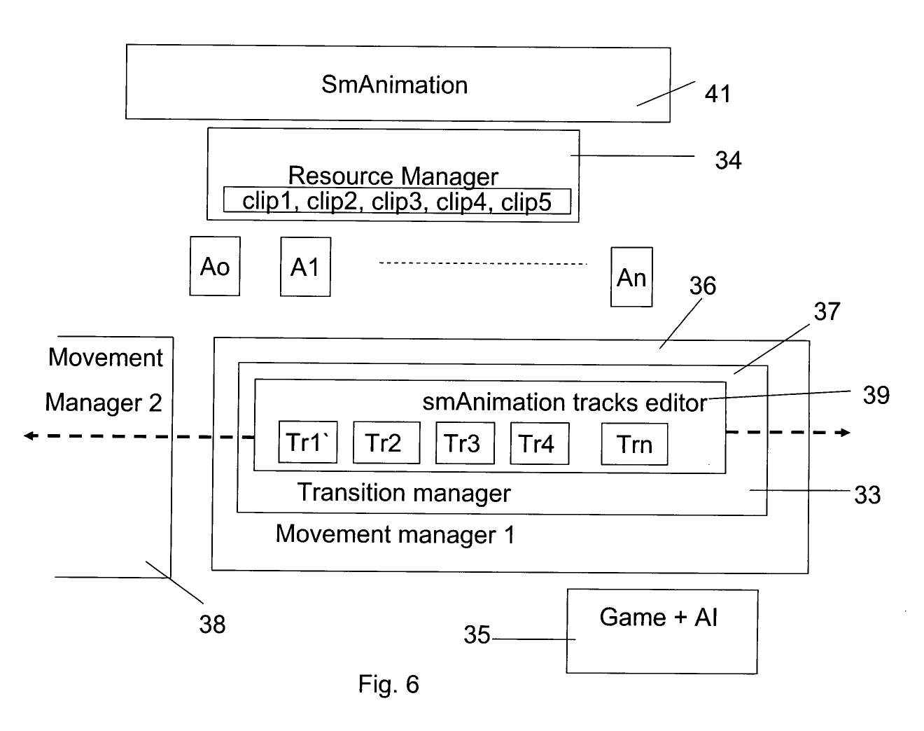

Reference is now made to FIG. 6, which is a simplified block diagram showing the hierarchy of elements within a system according to a preferred embodiment of the present invention. Resource manager 34 manages the available animation clips. Resource manager 34 stores actual data of the clips and therefore is limited in the number of clips that can be stored. Resource manager 34 may store typically five clips. The clips represent skeletal movements and are generic to the characters. The skeletal movements are subsequently grafted on to individual characters. Game artificial intelligence (AI) 35 is aware of the context of a current animation sequence and of user interactions and the like and orders any movement or behavior that it believes is needed. The AI 35 is connected to movement manager 36, and the movement manager 36 requests the animation from the resource manager 34. The movement manager notes where the character needs to move, say from A to B, finds the shortest path and determines whether a turn is required. The required animation, A₀ . . . Aₙ pointed to by the tracks editor 39 is provided to the transition manager 37 which has any number of tracks, Tr1 . . . Tr n and calculates transitions between different movements as well.

The transition manager 37 deals with bridging by noticing the categories of succeeding clips and selecting bridging clips when necessary.

Thus the Game AI tells the movement manager that it requires a character to walk. The transition manager notes that the character is currently sitting so notices that a transition clip is needed between sitting and standing before the character can walk.

The different movement managers, movement manager 1, movement manager 2 etc. represent different characters, as more than one character may appear on screen at the same time and require a different movement path.

The resource manager 34 then places the most immediately needed five clips in its five tracks in fast memory, so that all clips are available as needed. As mentioned, the resource manager 34 is concerned with actual storage of the data in the fast memory. Least used or last used clips are thrown out and frequently used clips are retained. A single clip can be used at the same time by more than one character. Thus several characters can play on screen with minimal utilization of resources.

The tracks can play simultaneously or in sequence, and the particular tracks may be assigned particular tasks. The tracks editor 39 determines the sequence of appearance of the tracks for any particular character. The transition manager 33 manages blending and/or bridging between clips. Thus clip1 may be assigned to a current animation. Clip2 may be assigned a bridging animation. Clip3 may be assigned a next animation. Clip4 and clip5 may be assigned body parts that are intended to move independently of the rest of the animation, thus a tail that wags independently of the rest of the dog. It is noted that the resource manager is held in common between different movement managers, so that several characters can share the same tracks and transitions if appearing simultaneously on the screen.

If there is a second character to be shown in the sequence, then a second movement manager 38 is used, as shown.

A unit known as smAnimation 41, manages the animation process using movement clips in the way described above to play movements of the characters. SmAnimation also manages speed of clips between frames as is described below.

In use the AI may decide that the dog, currently running across the screen, now needs to walk towards a bowl of food placed at a different direction from him. The movement manager decides that what is needed is for the run animation to be replaced first by a turn animation and then by a walk animation, as explained. All these animations are in a standing stance so no bridging animation is required. The resource manager retains movement clips of each category in fast or volatile memory. The transition manager actually manages a transition between the current running animation in track 1 and the turn animation in track 3. SmAnimation 41, as described in greater detail below plays the retrieved clips and the dog now turns. By the time the turn is finished, a walk animation is ready in the correct track to allow the turn animation to be blended into the walk animation. The dog now begins to walk in the correct direction.

Use of the resource manager 34 as explained ensures efficient management of memory for a priori undefined animation sequences in a limited resource device, according to a preferred embodiment of the present invention.

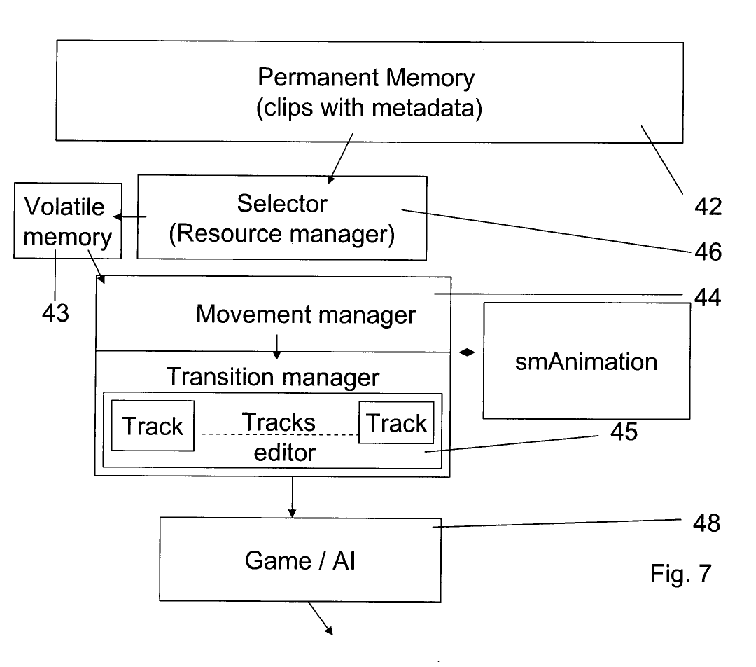

Reference is now made to FIG. 7 which is a simplified block diagram illustrating the hierarchical relationship extending from the artificial intelligence of the game itself to the memory management level. In FIG. 7 the resource manager is the unit that receives data from the permanent memory and stores it in a predetermined and limited number of tracks in volatile memory. Resource manager 46 works with the permanent memory 42 of the device and with volatile or fast memory 43 of the device. Movement animations in the permanent memory will simply not be rendered in time onto the specific character and a frame generated if called upon by the AI to appear in the sequence. On the other hand a limited resource device is unable to store endless numbers of animations in the volatile memory 43. The resource manager thus comprises a selector 46 which selects animation clips from the permanent memory according to the current context and places them in the volatile memory. In addition to selecting, the resource manager also manages access to the clips.

The fast memory is thus managed as a current animation register and stores a minimal number of animations that covers stances likely to be called upon in the current context. The movement manager 44 then selects from the movement animations available as needed for the given character in accordance with the game AI 48. The transition manager translates these requirements into a series of clips that can in practice be faded into each other. Clips selected by the movement and transition managers are stored as a series of virtual tracks in tracks editor 45. The game AI 48 tells the system what the character is supposed to do next. An animation module builds frames for output to the screen by rendering the movements or stances for the individual character.

The selector 46 operates by determining the current context of an animation. The context is information which is typically provided to the selector by the game AI 48. The game knows that a character is currently walking in search of a target and provides “walking” or “walking to target” as a context to the movement manager 44.

The selector operates via the movement and transition managers to retrieve animations likely to be called in the current context and place them in the volatile memory. Typically, the animations have been divided into categories, say motion, idle and turn and the selector finds one motion, one idle and one turn clip for the current context. Thus if the character is a dog currently walking towards a bowl of food then the selector may hold walking animations for walking in different directions, a turn animation for turning between the directions, and the idle animation may be the dog in front of the bowl of food eating. Commonly used stances are preferably retained in the tracks whilst irregularly used stances are added and removed as needed. Other criteria may also be used for determining which stances are retained, such as FIFO—first in first out, and timing-based rules. The volatile or fast memory may contain clips which can be used and reused, including use by more than one character, as explained above.

As a result of use of the resource manager of FIGS. 6 and 7, relatively limited combinations of animations can be used to provide relatively sophisticated animation sequences, even though a minimal number of animation clips are stored in the fast memory 43.

The embodiments are now described in greater detail.

As explained above, the operation of the movement manager and transition manager depends on information being available about individual animation clips. Each animation clip is thus preferably provided with metadata or information fields defining at least some of the following additional properties or semantics:

a. Velocity—the advancement ratio of the character in the 3D world when playing the animation.

b. Stance type—all animations are divided into ‘Stand’, ‘Sit’, and ‘Lie down’ postures, as explained above with reference to FIG. 2. It is noted that adding a new stance type simply requires defining a new name to the system, and preparing all necessary bridging clips.

c. Motion type—all animations needs to be classified as either ‘Move’, ‘Idle’, or ‘Turn’ type of motions, as explained above with reference to FIGS. 2A and 2B.

d. Loopable—is the animation clip loopable in nature. Typically idling clips are but say clips for waving hello are not.

Using the Stance Type of the current animation and the animation that is about to replace it, the transition manager introduces a seamless transition between the two, as per FIG. 4. If their stances are different, a ‘transition animation clip’ might be used to smooth the visual quality of the transition, FIG. 5.

The system preferably always has a currently defined ‘Move’ clip, and a current ‘Idle’ clip. These clips are selected according to the character state that the game defines. Thus if the game demands that the character state is “moving”, the system displays the ‘Move’ clip, and when standing—the ‘Idle’ clip is displayed.

The animating user can typically change the defined ‘Move’ and ‘Idle’ clips of the character at any time, choosing it from the existing set of clips of the character.

The animating user (or the game) can set a target for the character to reach, or alternatively the animating user or game may set an approach target. An approach target is one which the character never actually reaches but rather stops in front of the target at a user defined distance.

If the character is not at the designated target, the system uses the ‘Move’ animation to advance towards the target.

A target can be changed at any given moment by the artificial intelligence (AI) or by the user. The change typically causes the character to start advancing towards the newly set target immediately.

When the character has reached the target, the character displays a defined ‘Idle’ animation.

The ‘Turn’ animation for the current context may be selected automatically by the movement manager when turning at a spot towards a target, as described above in reference to FIG. 6, or it can be requested by the user. In the latter case, such a user requested turn operation overrides all other existing actions, but they may be resumed later.

Whenever a desired target is not in the direction currently faced by the character, the movement manager initiates a turn in the direction of the target. Once facing the target the system moves to the ‘Move’ animation itself.

A currently played animation can be switched by the movement manager or by the user at any given moment. The transition manager of FIG. 6 allows the transition to be carried out in a smooth and seamless way.

A ‘one time animation’ mechanism allows the user to activate a particular animation a single time at any given moment. Afterwards, the character returns to play the original played animation. Thus the character may be standing and then a “wave hello” clip can be activated, after which the character continues to stand. As explained with reference to FIG. 6, the one-time animation may be operated from one of the spare tracks in the transition manager.

The character can be frozen by the user at any time, causing both the animation clip and the movement to freeze.

The system preferably supplies the user with indication functions regarding its state, location, motion, active animation clip, and other required properties. These indicators allow the user to define his own fine control based on feedback from the movement management system in real time.

General Components

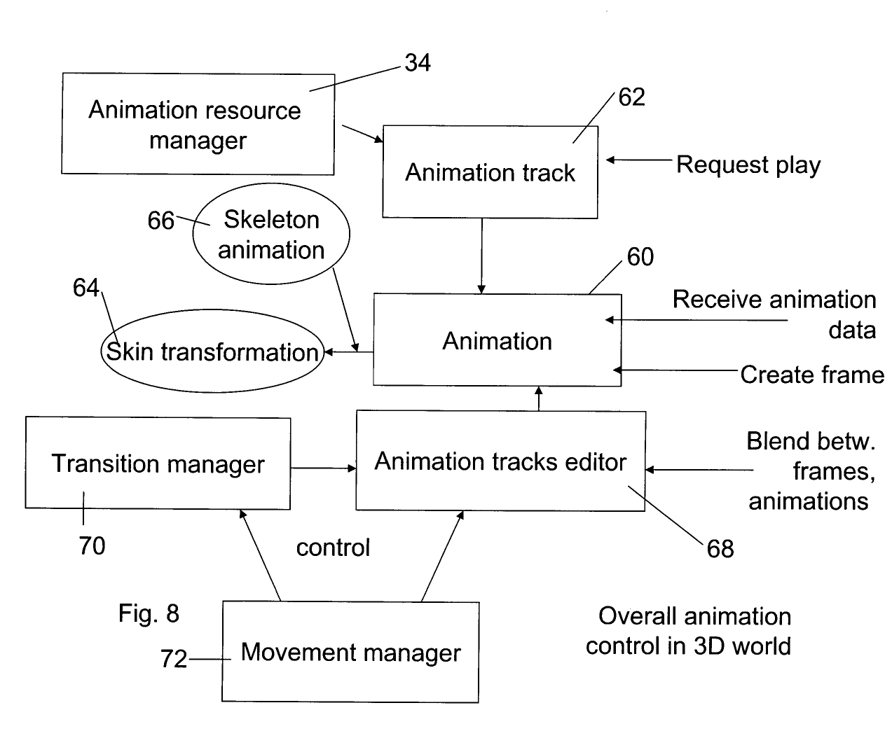

Reference is now made to FIG. 8, which shows the various software components that go to make up an animation movement manager for a limited resource device according to a preferred embodiment of the present invention. The following presents the structures and classes that combine to form the mechanism described hereinabove.

smAnimation 60

The smAnimation class 60 is responsible for the loading and handling of the animation data. It also enables retrieval of joint data and configuration at a desired frame/time. By joint data is meant data that can be applied to different characters at the same time. This functionality is used to play the animation, by generating a desired key frame, at a given time. Although handling the animation's data, this class does not initiate the play of a character animation but rather calculates a frame for the screen based on the animation data, when requested by the playing mechanism, which is the track class to be discussed below.

The reason for such joint data is the ability to share the same animation data among several characters when building the frame. If each animation is at a different frame location, play speed, etc . . . however, this mechanism is not sufficient to allow frame building for several characters.

The presently preferred embodiments therefore provide smAnimation 60, which is in charge of the animation data and has the knowledge to calculate a desired frame in time when asked to.

Given a skin, which is the three-dimensional shape and texture of a character, the character still needs to be able to move. Movement is added to a character in an animation sequence. The animation sequence controls the animation of all the body parts through a tree of animated matrices. This technique is well known in the game industry and is called Skin Animation or Skeletal Animation 66—a single mesh model is influenced by a set of matrices which are constructed as a tree structure. This tree structure of matrices is called a Skeleton. The skeleton defines the movement of the individual character and is combined onto the skin by skin transformation object 64 at run time to give the character the individual movement. In accordance with the present embodiments the same skeleton can be reused for similar movements of different characters. Reuse of the same skeleton allows for conservation of computing resources.

Skin transformation object 64 may be provided to manage the transformations described above for the various characters.

The present embodiments add to the well-known technique in that the same set of skeletons or movements or stances are provided for all of the characters. Thus, just a single walking skeleton needs to be kept in fast memory and applied to any dog that needs it.

A problem that was solved through the smAnimation is a need to keep frame rates apparently fixed, so that no matter what the actual frame rate (FPS) relative to the clip, the animation will still seem fluent and play at the same speed. The present embodiments implement a frame blending mechanism, so that it is not in fact necessary to render the next frame in the clip sequence, but it is possible to provide an exact desired frame by generating an intermediate frame or jumping to a succeeding frame in the clip sequence. There is thus provided a speed management step of blending between movement stages of the movement clip (clip frames) to form movement frames (rendered frame) in between the movement stages stored in the movement clip. Thus, if the animation is to be played at 20 FPS (50 millisecond per frame) and in fact there is an interval of 70 ms between the last frame and the current frame, then, instead of fetching the following frame or the one after, the smAnimation 60 in fact calculates a new frame which is the combination of the next frame and the one after.

So, if the previous frame was for example frame 4, then:

$$\begin{matrix}Required Frame = Previous Frame + 70 / 50 \\ = Previous Frame + 1.4 \\ = 4 + 1.4 = Frame 5.5\end{matrix}$$

SmAnimation uses the above calculation to obtain the new frame, frame 5.5, which is the combination of frame 5 and frame 6 of the animation sequence.

The above is referred to as key frame blending.

smAnimationResourceManager 34

The Resource Manager 34, manages all existing animations in memory. It prevents multiple loading of the same animation, and keeps track of the most frequently used animations in order to prevent frequent loading of these animations—this is done by keeping small numbers of clips in memory.

SmAnimation 60 stores data of a given animation and can be used by multiple clients. The clients in this case are smAnimationTracks Tr1 . . . . Trn in FIG. 6—which are described below. Use of the SmAnimation class 60 ensures that there should not be more then one instance of a given animation in memory at any given moment.

smAnimationTrack 62

The SmAnimation class is responsible for the activation of any animation.

The smAnimation class above contains the actual animation data and the functionality to fetch a desired frame. The smAnimationTrack 62 is the client that activates the animation for a character, controls the play speed, current frame in time, direction of play, pause, replay, and other features that refer directly to the way the user or system controls the animation play.

Another desirable feature that the smAnimationTrack 62 contains is the ability to generate the given animation key frame scaled by a factor. The importance of this feature will be discussed hereinbelow.

It is mentioned that tracks have an automatic operation mode. The class is given a desired scale factor, the blend values explained hereinbelow, and the period of time to achieve a transition. The track autonomously knows how to apply the blend operation over a sequence of frames by determining a particular brightness level for each frame in the sequence. The track signals to the operator (the Tracks Editor discussed below) when the value calculated is reached by a given frame.

smAnimationTracksEditor 68

In many cases a character needs to run several animations or animation clips simultaneously. An example of this is when we want to switch from a ‘Walk’ animation to a ‘Run’ animation, as per FIG. 4 above. The switchover comprises blending of the two animations so that as the first animation fades away, the new animation begins to fade in and play smoothly. The blend effect from fade out and fade in operations works smoothly in most cases, causing the animation to look as if the character has switched from ‘Walk’ to ‘Run’ without any flickering or visual artifacts.

The transition manager 70 in fact manages several tracks at the same time and blends between their frames during a render or update cycle of the animation procedure.

As explained above, in order for the transition to look good and convincing, the two animations should not be too different from one another. Thus, an animation of a dog standing on two legs, blended with an animation of a dog lying down while scratching will look bad.

Also, the blending factor should be affine, i.e., the sum of weights over the two animations should be 1.0 at all points in time. The constant sum property of the weights is apparent from FIG. 4.

Another desirable goal of transition manager 70 is to be able to blend-in or replace the animation of a single body part in the played animation, hence to achieve different animation for a single part of a body, or a blend of Inverse Kinematics (IK) with the animation. An example is that when a dog walks, it can simultaneously wag its tail. This involves playing a separate animation which controls only the tail and is blended with the existing walk animation. As a further example, the character may turn its head to look at a point in the world. Such head turning may be achieved by using IK to rotate the head towards the desired target, while running the original animation for the rest of the body.

Notice that in the above two examples a unique blend is needed. Only a part of the original animation tree is affected, which is either replaced or blended with the partial animation. In today's advanced game technology this technique is called channel or slot blending.

smTransitionManager 70

While the Tracks Editor 68 enables using and blending of several tracks simultaneously, the control over the blend is completely manual and is up to the animating user to set such control. For example, in order to generate a seamless fade-out/fade-in blend that has been shown before, the user has to compute the weights of the blend during each frame and set it using the smAnimationTracksEditor 68.

The mechanism allows for minimum user intervention if not needed. Hence, in order to control character motion and behavior, a smart mechanism switches between animations without user intervention. The mechanism matches the transition frames as much as possible. That is the mechanism chooses the best matching frame in the new animation to the current played frame.

The smTransitionManager 70 carries out the above as follows: It receives a user call to change the animation clip. It knows automatically how to schedule the animation clip, and blends it using the scheme of FIG. 4 (affine combination of weights). At the end of the blend it removes the already faded out animation clip from the mechanism.

As mentioned above, such a mechanism is not sufficient for a seamless transition, since in many cases two completely different animations have to be exchanged. An example for such a case is the dog switching from a ‘Run’ animation to a ‘Sit’ animation, as explained above with reference to FIG. 5.

As explained, each animation is categorized by its stance—for example ‘Stand’, ‘Sit’ and ‘Lie-down’. Having established the stance, the principle is that blending between two animations from the same stance is most likely to be seamless, while different stances cannot be blended seamlessly, hence the bridging clips or Transition Animations referred to above. The bridging clips are short animation clips simulating passage from one stance to another—thus: a dog begins the clip standing and then moves to a sit position, etc. . . . These clips are fixed or user configurable.

The category determination unit, 30 in FIG. 3, is an automatic mechanism that checks stances of the current and next clip when receiving a request to switch animations. If the stances are the same, the usual, direct blending scheme of FIG. 4 is used. Otherwise, the smTransitionManager 70 first initiates a blend from a current animation to the transition animation, and when this blend is done, it automatically initiates another blend from the transition animation to the new desired animation.

A further point is the choice of frame in the new animation clip to start the animation from.

Currently almost all animations start any particular motion with the same legs, and are carried out over a complete cycle. The preferred embodiments calculate the relative location of the frame in the current animation and match the new animation to start from the same relative location. Although not perfect, the described technique has proven itself to be good enough for seamless motion quality. Thus a frame taken at two steps or one second from the start of the clip may safely be blended with the next clip also starting at one second from the start.

An alternative embodiment uses a technique that involves pre-computed matching points along the animations frames.

In this alternative embodiment the closed set of all of the character's animations is defined. A pre-processing operation involving pattern matching is applied in order to generate a table of most promising transition points between animations.

For example, given a desired transition from a ‘Walk’ animation to a ‘Jump’ animation, the pre-processing finds and tabulates the best fitting frame in the ‘Jump’ sequence from each frame in the ‘Walk’ sequence. The best fitting frame can be best described as the frame in the new animation that matches the given frame of the current animation the most.

In a particularly preferred embodiment, given the period of time for the blending process, matching can be carried out over the entire sequence of frame contained in the blend time window.

The additional requirements of the preprocessing is as follows:

1. All animations are to be known in advance. This is generally the case.

2. Each animation requires a small amount of additional memory for the transition table. The additional memory is approximately 1 Kb per animation when there is a total of about 50 animations but as will be appreciated the table per animation gets larger as more animations are provided since more possible transitions have to be catered for.

smMovementMgr 72

Previously described objects deal with animations, blending between them and animation control. The following describes any mechanism that supplies the connection between a character animation and its movement in the virtual 3D world.

The mechanism connects between the animations, their semantics, and the desired motions of the character when playing the animations.

An example is when the character plays the ‘Run’ animation. During the play it moves forward and matches the velocity along the ground to the velocity of the animation, hence convincing the viewer that it really is running.

Much like the concept of the transition manager above which distinguishes between stances, the movement manager also distinguishes between types of animations. The movement manager distinguishes between ‘Motion’ animations, ‘Idle’ animations (when the character does not move along the ground, but rather keep its position in the world), and ‘Turn’ animations.

Having established the categories, the system registers a ‘Move’ and ‘Idle’ animation, as well as current location and target location.

At each moment the user can change the target, and when doing so the manager sets course to the target. If the character is Idle, the manager initiates a blend to the Move animation through the usage of the Transition Manager [TM], and sets the course towards the new target. If the direction towards target is not aligned with the direction of the character, the manager initiates a Turn animation. The same technique is used when changing the target location during an already initiated movement.

The user can switch either Idle or Move animations at any given moment, hence causing any one of the following scenarios:
Switch to a Move animation during motion causes a blend to the new animation.
Switch to a Move animation during Idle will only take effect at the next motion opportunity.
Switch to a new Idle motion during Idle causes a blend to the new Idle animation.
Switch to a new Idle during a current motion animation takes effect at the next stopping point.

Whenever a target which differs from the current location is set, the manager initiates a movement path towards the target, and activates the Move animation. When a target is reached a pre-defined Idle animation is blended in and takes place.

Again, all of these transitions use the transition manager as described above. Hence the control mechanism does not need to deal with animations directly.

When a turn is initiated by the movement manager (MM), it is blended with the previous animation, hence looking quite natural. On turn termination, the turn animation is blended with the next animation, which may be an Idle animation if in Idle state, or Move animation if within movement.

Examples of Use Cases

The following gives examples of correctly using the Movement Manager 36 (FIG. 6). The examples show how a user can use the high level control functionality to achieve a desired behavior.

In the following the example character is a dog, which walks, runs, sits up and scratches, wags its tail etc.

Also, in order to allow a better understanding of the internal control flow, the internal flow control is given after the pseudocode in the first example.

Random Behavior Simulation

Goal:

Displaying a variety of character behaviors in a random fashion. This is done by setting a target, and moving with a randomly chosen animation towards it. Once at the target, the character moves to idle state, and then we choose a new target with different Move and Idle animation, so the entire motion has different motions and idle behaviors.

Pseudo Code:
Set a random ‘Idle’ and ‘Move’ animations.
Set a random target location within a desired limited area (visible on screen)
When the character reaches the target wait a rest time period, and then start over again.
If desired, a one-time animation can be introduced randomly from time to time.

Partial Internal Control Flow (from Idle State Until Reaching the Next Target):

Control flow is as follows:

1. The movement manager tests to see if the target is being faced by the character—if not, a turn is initiated.

2. The transition manager initiates a blend from idle to either turn or move animation by blending tracks—the tracks activate their animation objects according to their state.

3. During the turn, the movement manager controls the dog's rotation within the animation.

4. If a turn is carried out, then on completion of the turn the movement manager sets the next move animation.

5. During the move animation blend, the movement manager begins to move the dog towards the target with the appropriate velocity in accordance with the animation velocity and track playback speed.

6. During the move, the movement manager fixes the orientation if needed, and if big angles are encountered, the movement manager again initiates a turn.

7. When a target is reached, the movement manager stops moving the dog, and initiates a switch to the idle animation.

8. The transition manager makes the transition to the idle animation by blending tracks. The tracks themselves activate their animation objects in accordance with the track' activation mode and data.

Table 1 below shows control flow over time through a chart of active components:

TABLE 1
Control flow per component over time.

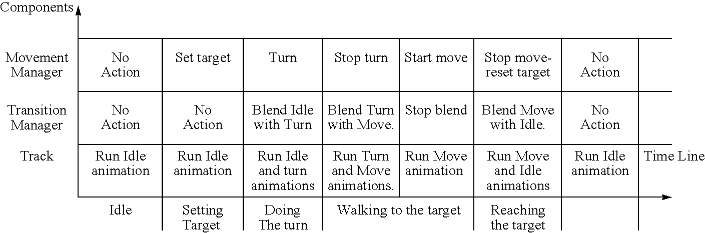

Interactive Control Over the Character

Goal:

To allow user control over the character by pressing the direction keys. Using the following pseudo code the user is able set the direction of travel of the character and otherwise affect the character.

Pseudo Code:
Keep last user key press direction (or no action otherwise).
If key press, set the target in the desired direction from the character.
If key release (or no press action, depends on implementation), set the target to be the same as the current location (one can simply use ‘stop’ function).
If some time passes from last press, change ‘Idle’ animation to ‘Sleep’ or ‘Bored’ animation.

Taking the Dog Character to Eat

Goal:

To display the dog at the center of the screen, walking towards a bowl of food and eating from it.

Pseudo Code:
Set the dog at the center of screen.
Set ‘Walk’ as the ‘Move’ animation, and ‘Eat’ as the ‘Idle’ animation.
Set the approach target as the location of the bowl, and the distance as the size of about half the dog's size.
When the inquiry of ‘isldle’ is returned as ‘true’ by the dog, activate the bowl's animation sequence (of being eaten).

It is expected that during the life of this patent many relevant devices and systems will be developed and the scope of the terms herein, particularly of the terms animation, movement manager, transition, fade, transition manager, volatile memory, cache memory, fast memory, etc is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for transition management in an a priori undefined animation sequence that combines a plurality of separate animation clips, the apparatus comprising:
a) a category determination unit for determination of category classifications respectively of a first and a succeeding animation clip in said sequence and indicating whether said category classifications are the same or different, and
b) a blending unit configured for:
i) blending said first animation clip directly into said succeeding animation clip if said category classifications are the same, and
ii) selecting a bridging animation clip for bridging between said first and said succeeding animation units if said category classifications are different, such that said first animation clip is blended into said bridging animation clip and said bridging animation clip is blended into said succeeding animation clip.

2. Apparatus according to claim 1, wherein each of said animation clips comprises a category classification.

3. Apparatus according to claim 2, wherein said category classification is included as metadata in association with said clip.

4. Apparatus according to claim 1, wherein said animation sequence involves a plurality of different activities of an animated character and said category classifications are stance modes of said character.

5. Apparatus for movement management in an a priori undefined animation sequence comprising a plurality of movement clips, for use in a limited resource device having permanent memory and a limited amount of faster volatile memory, the apparatus comprising:
a) a movement clip register in said volatile memory able to take a limited number of movement clips at any given time;
b) a resource management unit for placing animation clips of a plurality of different categories from said permanent memory in said movement clip register;
c) a movement manager unit for defining an intended movement of a given character; and
d) a track manager, associated with said resource management unit, for translating an intended movement into a series of movement clips, and ensuring that said resource management unit has clips of said series available in said volatile memory.

6. Apparatus according to claim 5, wherein said movement manager unit is associated with an animation context unit to receive therefrom current context data of said animation sequence, therefrom to define said intended movement.

7. Apparatus according to claim 5, wherein said movement clips are categorized, and said categories are at least one member of the group consisting of a movement category, an idle category and a turn category.

8. The apparatus of claim 5, wherein said limited number is predefined by available resources of the device.

9. The apparatus of claim 5, wherein said resource management unit is configured to store most likely succeeding clips.

10. The apparatus of claim 9, wherein said resource management unit is configured to store clips on a FIFO (first in first out) basis.

11. Method for transition management in an a priori undefined animation sequence that combines a plurality of separate animation clips, the method comprising:
a) determining of category classifications respectively of a first and a succeeding animation clip in said sequence and indicating whether said category classifications are the same or different, and
b) i) blending said first animation clip directly into said succeeding animation clip if said category classifications are the same, and
ii) selecting a bridging animation clip for bridging between said first and said succeeding animation units if said category classifications are different, such that said first animation clip is blended into said bridging animation clip and said bridging animation clip is blended into said succeeding animation clip.

12. Method according to claim 11, wherein said category classification is included as metadata in association with said clip.

13. Method according to claim 11, wherein said animation sequence involves a plurality of different activities of an animated character and said category classifications are stance modes of said character.

14. Method for movement management in an a priori undefined animation sequence comprising a plurality of movement clips, comprising:
selecting, from a relatively slow memory, movement clips of a plurality of different categories,
placing said selected movement clips in a current movement clip register being in relatively fast memory; and
selecting a movement clip for playing, by taking a movement clip of a currently desired category from said current movement clip register.

15. Method according to claim 14, further comprising receiving current context data of said animation sequence, therewith to define a movement of a character, and
using said defined movement to carry out said selecting of movement clips for each of said categories.

16. Method according to claim 14, wherein said categories are at least one member of the group consisting of a movement category, an idle category and a turn category.

17. Method according to claim 14, further comprising a speed management step of blending between movement stages of said movement clip to form movement frames in between the movement stages stored in said movement clip.
